(19) United States
(12) Patent Application Publication
(10) Pub. No.: US 2016/0203344 A1
(43) Pub. Date: Jul. 14, 2016

(54) Electronic Device Protected against Tampering

(71) Applicant: ENDRESS+HAUSER FLOWTEC AG, Reinach (BL) (CH)

(72) Inventors: Nikolai FINK, Aesch (CH); Alfred UMKEHRER, Hopferau (DE); Timo KRETZLER, Binzen (DE); Wilhelm STAUDT, Aesch (CH)

(21) Appl. No.: 14/913,396

(22) PCT Filed: Jul. 8, 2014
(86) PCT No.: PCT/EP2014/064576

§ 371 Date: Feb. 22, 2016

(30) Foreign Application Priority Data
Aug. 22, 2013 (DE) 10 2013 109 096.6

(51) Int. Cl. G06F 21/86

(52) U.S. Cl. CPC G06F 21/86

(57) ABSTRACT

An electronic device comprises a microprocessor having a data input; a data output and a control input as well as at least one memory unit, especially a memory unit formed by means of a persistent memory component. The microprocessor includes at least two operating modes selectively activatable via the control input and is adapted to execute in a first operating mode at least one predetermined control program, in order to process digital data incoming via the data input and/or in order to output digital data on the data output, and in a second operating mode to be reprogrammable, in such a manner that at least one value of a parameter, which influences execution of the at least one process flow program by the microprocessor, is changeable. The memory unit is additionally adapted to react to each activating of the second operating mode with a change of a memory content, in such a manner that said memory content, represents a frequency, with which the second operating mode has been activated within a predetermined period of time.

The invention relates to an electronic device, especially an electronic device embodied as a measuring and/or switching device of industrial measuring and automation technology and/or an electronic device suitable for application in certification obligatory traffic in goods, wherein the electronic device comprises a microprocessor with a data input, a data output and a control input as well as at least one memory unit. The invention relates as well to a method for operating such an electronic device.

In industrial measuring and automation technology, especially also in connection with the automation of chemical processes or procedures for producing a product from a raw or starting material by use of chemical, physical or biological processes and/or the automated control of industrial plants or, however, also in connection with the operation of certification obligatory transfer systems, for example, fueling plants or filling plants, electronic devices are applied installed directly at the respective plant. These electronic devices are often also referred to as field devices. Such electronic devices can be actuator field devices, for example, electronic motor, respectively valve, controls, or, however, also sensor field devices, namely measuring devices, such as e.g. Coriolis mass flow measuring devices, vibronic density measuring devices, magneto-inductive flow measuring devices, vortex flow measuring devices, ultrasound flow measuring devices, thermal mass flow measuring devices, pressure measuring devices, fill level measuring devices, vibronic fill level limit switches, temperature measuring devices, pH-value measuring devices, etc., which serve respectively for ascertaining measured values representing, in each case, a physical and/or chemical, measured variable, which varies as a function of time within a predetermined measurement range as well as for producing, in each case, at least one—digital or analog—measured value signal transmitting the measured values externally of the respective measuring device. The measured variable respectively to be registered by the electronic device formed by the measuring device, in given cases, also a certifiable, measuring device, can, depending on application, be, for example, a mass flow, a density, a viscosity, a fill level or a limit level, a pressure, a pH-value, an electrical conductivity or a temperature or the like, of a liquid, powdered, vaporous or gaseous medium, which is conveyed, respectively held, in a corresponding container, such as e.g. a pipeline or a tank. Such electronic devices in the form of measuring devices and known, per se, to those skilled in the art are disclosed in, among others, EP-A 1 591 977, GB-A 2,229,897, US-A 2001/0016802, US-A 2003/0236579, US-A 2005/0137719, US-A 2010/0026322, US-A 2008/0288933, US-A 2011/0062942, U.S. Pat. No. 5,672,975, U.S. Pat. No. 6,014,100, U.S. Pat. No. 6,140,940, U.S. Pat. No. 6,452,493, U.S. Pat. No. 6,472,884, U.S. Pat. No. 6,684,340, U.S. Pat. No. 6,854,055, U.S. Pat. No. 7,162,651, U.S. Pat. No. 7,296,482, U.S. Pat. No. 7,630,844, U.S. Pat. No. 7,778,784, U.S. Pat. No. 7,792,646, WO-A 00/26739, WO-A 00/48157, WO-A 01/71291, WO-A 03/106931, WO-A 2008/091548, WO-A 2009/002341, WO-A 2011/005938, WO-A 2012/009003, WO-A 2012/159683, WO-A 2012/163608, WO-A 88/02476, WO-A 88/02853, WO-A 94/20940, WO-A 95/08123, WO-A 95/08758, or also the not pre-published German application 102013100799.6 of the applicant, respectively are sold by the applicant, for example, under the marks, t-trend ATT12, Promag 53H, Prowirl 73F, Promass E 200, Promass F 200, Promass 83X, or Promass 84F.

For registering the respective process variables, electronic devices formed as measuring device have, in each case, a corresponding physical to electrical or chemical to electrical, measuring transducer. Such is most often applied in a wall of the container respectively containing the medium or in the course of a line, for example, a pipeline, respectively conveying the medium and serves to generate, at least one, first of all analog, electrical measurement signal corresponding to the measured variable to be registered, namely an electrical measurement signal representing its time curve. The analog electrical measurement signal is, in turn, further processed by means of a device electronics electrically connected to the measuring transducer, in such a manner that corresponding measured values are ascertained for the measured variables. The device electronics of the respective measuring device is most often accommodated in a comparatively robust, for instance, impact, pressure, explosion and/or weather resistant, electronics housing. This can be arranged e.g. removed from the measuring transducer and connected with such only via a flexible cable; it can, however, also be arranged directly on the measuring transducer, respectively in a measuring transducer housing separately housing the measuring transducer.

The device electronics of electronic devices of the aforementioned type is during operation additionally electrically connected via corresponding connection terminals and therewith connected electrical connecting lines to a superordinated electronic data processing system most often arranged spatially removed from the respective measuring device, most often also spatially distributed. In the case of an electronic device formed as a measuring device and consequently sensor containing, the measured values produced by the respective device are forwarded, for example, to the mentioned data processing system by means of the measured value signal in a format processable by the data processing system. Very distributed, in such case, is not least of all also true for the case, in which measured value signals are transmitted via greater distances lying, for example, in the order of magnitude from 10 m to some hundreds of meters and beyond, where analog electrical current signals are applied, namely analog measured value signals, in the case of which an instantaneous electrical current level represents an impressed signal current equally as well a signal current variable within a predetermined measuring range, namely within an electrical current range reserved for transmission of measured values, in each case, a signal current exactly corresponding to a measured value for the measured variable. Used in industrial measurements technology for this are often so-called 4-20 mA electrical current loops, consequently, as measured value signals, such signal currents, which are variable within a measuring range lying between a lower limit electrical current level, for instance, fixed at 3.8 mA—, at times, also referenced as electrical current leading zero-point or life-zero-value—as well as an upper limit electrical current level fixed at, for instance, 20.5 mA. Lying beneath, respectively above, the electrical current level range of the mentioned measuring range, among other things, also defined in the standard DIN IEC 60381-1, are, in the case of 4-20 mA electrical current loops, electrical current levels most often reserved for signaling earlier defined special operating conditions differing from a normal operating mode corresponding to the normal measuring operation of the respective measuring device, thus, for example, alarm states as a result of a measured variable lying outside a measuring range specified for the measuring device or as a result of a failure of the respective measuring transducer, for instance, also in order to satisfy the requirements formulated in the NAMUR recommendation NE43:18.01.1994 for unified signal level for downtime information for digital measurement transmitters with analog output signal.

For producing the measured value signal in the case of electronic devices formed as measuring devices, an analog to digital converter arranged, for example, directly on the measuring transducer and/or within the mentioned electronics housing, first of all, wins from the analog electrical measurement signal of the measuring transducer a digital measurement signal representing such. For additional processing of the digital measurement signal, namely for producing from digital measured values representing the particular measured variable as well as for transforming the mentioned measured values into at least one measured value signal transferable and evaluatable externally of the electronic device, respectively its device electronics, the particular device electronics of the measuring devices includes, furthermore, a transmitter circuit receiving the digital measurement signal. As, among other things, also shown in the above mentioned US-A 2001/0016802, US-A 2010/0026322, US-A 2011/0062942, U.S. Pat. No. 7,630,844, U.S. Pat. No. 7,792,646, U.S. Pat. No. 7,778,784, U.S. Pat. No. 6,452,493, U.S. Pat. No. 6,014,100, WO-A 95/08123 or WO-A 2012/009003, in each case, the transmitter circuits in the case of modern electronic devices of the aforementioned type are most often formed by means of a digital microprocessor having, at times, also more than one processor and/or a digital signal processor (DSP), to which the digital measurement signal is fed via a data input. Said microprocessor is, among other things, also adapted during operation automatically to process digital data incoming via a data input by performing at least one corresponding predetermined process flow program, for example, thus based on the digital measurement signal on the data input to generate a measured values sequence, namely under control of the process flow program a sequence of respective digital measured values instantaneously representing the measured variable and representing a time curve of the measured variable won for different points in time, and to output, on a corresponding data output, digital data ascertained based on the data processing. The digital data on the data output can accordingly be, for example, digital measured values output in real time. For storing the at least one process flow program, transmitter circuits of the aforementioned type, consequently the electronic device respectively formed therewith, have usually one or more corresponding non-volatile memories for storing program code for the at least one control program, respectively, in the case of a modularly organized control program, for a number of individual program code modules, as well as at least one volatile memory, in which the control program to be executed by the microprocessor can be correspondingly loaded during operation of the electronic device.

For the mentioned case, in which an analog electrical current signal should be output as measured value signal, transmitter circuits of the aforementioned type, consequently electronic devices formed therewith, have, furthermore, an electrical current interface controlled by the microprocessor and having at least one electrical current output and a control input coupled with the data output of the microprocessor. The electrical current interface is adapted to let the signal current flow through the electrical current output and during that to hold the electrical current level of the signal current at a steady electrical current level predetermined by the microprocessor at the data output, for example, thus corresponding to the currently ascertained measured value. The electrical current interface can, in such case, be embodied as a passive interface, namely one setting an electrical current in the sense of a load modulation driven by a supply circuit arranged externally of the measuring device, or as an active interface, namely one varying an electrical current driven by an internal supply circuit of the measuring device.

Electronic devices of the type being discussed should also in the case of a measuring device after their start-up, for example, namely after it has entered regular measuring operation, consequently after the microprocessor is in a normal operating mode, in which it can execute, respectively executes, the at least one control program, be, at times, checked—be it on impetus of the user operating the device and/or on demand of an authority overseeing the measuring point formed by means of the electronic device —, concerning whether the required accuracy of measurement, respectively the accuracy of measurement stated in the specification, namely that accuracy, with which the measured values for the measured variable are ascertained, respectively with which the measured variable is ultimately mapped to the measured value signal, is still being reliably achieved; this not least of all also for the case, in which the electronic device is, such as already mentioned, used in certification obligatory traffic in goods, for instance, as a component of a certification obligatory transfer system. In the course of such a checking of electronic devices of the type being discussed, for example, in the sense of performing a calibrating or a new certification, it can, at times, also be required that the microprocessor be reprogrammed for the purpose of correspondingly adjusting the transmitter circuit, in such a manner that the at least one control program, respectively its program code, is correspondingly revised, in that a value of a parameter, which influences the performance of the mentioned process flow program by the microprocessor, respectively values of a number of such parameters influencing the performance of the at least one process flow program by the microprocessor, is/are changed.

Such modifications of one or more such process flow programs, not least of all also such, which intend a bringing about of the required accuracy of measurement, usually are not permitted to be performed, respectively cannot be performed, in the case of electronic devices of the above-described type, not least of all also such, which are subject to a certification requirement, when the microprocessor is working in the normal operating mode, in which case a device operated as a measuring device thus is working in normal measuring operation. Rather, the microprocessor must, for such purpose, first of all, be placed in a corresponding special operating mode, namely in an operating mode permitting modifications, for example, even in the presence of an examiner charged with the testing, respectively an examiner commissioned by the relevant authority. The inputs required for the modification of the process flow program can be performed, for example, via a corresponding onboard servicing element of the electronic device and/or via an external servicing device communicating with the microprocessor via an adapter in the form of a service interface.

In order to prevent, respectively, in given cases, to be able to discover as early as possible, a tampering of the electronic device, namely an unauthorized modification of the process flow program after an approval, respectively release, of the respective electronic device, for instance, tampering as a result of an unpermitted accessing of a microprocessor placed in the previously indicated, special operating mode by non-authorized personnel, electronic devices of the type being discussed are most often provided with corresponding protective measures against impermissible accessing in the special operating mode. Such protective measures are frequently composed of a password protected access to the microprocessor in combination with a switch mounted within the electronics housing, which is actuatable only manually and only after opening the electronics housing, for activating the special operating mode, respectively for renewed deactivating of the special operating mode. For such purpose, the switch is adapted, for example, embodied, as a DIP switch, in order to generate on the control input of the microprocessor a signal level pattern, for example, in the form of a bit sequence, activating the second operating mode, for example, also both activating the second operating mode as well as also at the same time deactivating the first operating mode. Additionally, the switch is, not least of all also in the case of electronic devices subject to a certification requirement and/or for guarantee and liability reasons, most often also protected against unauthorized, respectively undetected, actuation, for example, by placing thereon and/or on the electronics housing a seal, for instance, in the form of an adhesive label or a wax or lead seal, which, first of all, resists an opening of the electronics housing, respectively an actuating of the switch, and which additionally cannot be removed, without being recognizably destroyed.

A disadvantage of such conventional protective measures for electronic devices of the aforementioned type is, on the one hand, that a large number of passwords must be handled, namely produced, managed, and renewed and additionally also transmitted with traceable documentation to, as a rule, a number of persons authorized for modification of process flow programs, this adding up consequently to implementation of an enormous organizational, not least of all, however, also an enormous information technology, effort on the part of the operator of the respective device. Also, the particular password must be input on-site via a servicing element, which is for space reasons most often very small, respectively the broken seal must be appropriately replaced after leaving the special operating mode. Additionally, however, also the case can occur that a current password is, first of all, not available on-site as required for a spontaneous accessing of the special operating mode by actually authorized personnel, for instance, because of incorrect delivery, respectively ordering, because of incorrect parametering, respectively because of occurrence of an error in the operation, be it for reasons of incorrect transmission or caused by an exceeding of an expiration date of a previously valid password, or also that a password was wrongly input a number of times in a manner leading to a longer lasting blocking of access to the special operating mode, in each case, along with corresponding delays of possibly pressing alteration measures for the device. On the other hand, these protectives measures are also not able to document the point in time of a possible tampering of the affected device, so that a corresponding tracing procedure is not supported. Moreover, the aforementioned protective measures are also not completely, respectively insurmountably, secured against unrecognized misuse, respectively against undetected falsification.

Taking this into consideration, an object of the invention is to provide for an electronic device a protective measure, which, on the one hand, enables a comparatively simple accessing of a special operating mode permitting modifications of a control program to be performed by a microprocessor in a regular operating mode and which, on the other hand, is able reliably to document any accessing of the special operating mode, in given cases, also without requiring password- and/or seal-based protective measures.

For achieving the object, the invention resides in an electronic device, which comprises a microprocessor having a data input, a data output and a control input as well as at least one memory unit, for example, a memory unit formed by means of a persistent memory component. The microprocessor of the electronic device of the invention includes at least two operating modes, for example, operating modes selectively activatable exclusively via the control input, for instance, by means of binary signal level, respectively clock sequences formed therewith, and is additionally adapted to execute in a first operating mode at least one predetermined control program, in order to process digital data incoming via the data input, for example, to digital measured values, and/or in order to output digital data, for example, also in real time, on the data output, as well as in a second operating mode, for example, activatable alternatively to or also simultaneously with the first operating mode, to be reprogrammable, in such a manner that at least one value of a parameter, which influences the execution of the at least one process flow program by the microprocessor, is changeable. Additionally, the memory unit of the electronic device of the invention is adapted to react to each activating of the second operating mode with a change of a memory content, in such a manner that said memory content represents a frequency, with which the second operating mode has been activated within a predetermined period of time.

Furthermore, the invention also resides in using such an electronic device in certification obligatory traffic in goods, for example, for ascertaining measured values for a physical or chemical, measured variable of a medium, for example, a fluid medium, for example, a gas or a liquid.

Moreover, the invention resides also in a method for operating such an electronic device, for example, also an electronic device applied in certification obligatory traffic in goods, which method comprises:
activating the first operating mode for executing the at least one process flow program by means of the microprocessor;
activating the second operating mode for reprogramming the microprocessor;
and modifying the memory content by a predetermined magnitude in such a manner that the memory content represents a frequency, which is increased by the amount of the magnitude and with which the second operating mode has been activated within a predetermined period of time.

In a first embodiment of the invention, the microprocessor is adapted not to be reprogrammable in the first operating mode, for example, also in such a manner that the value of no parameter influencing the execution of the at least one process flow program by the microprocessor is changeable.

In a second embodiment of the invention, it is provided that the memory content comprises a numerical value for a counter variable representing a counter level, which numerical value in the case of activating the second operating mode, in each case, is changed by a predetermined magnitude, for example, one, for example, namely, in each case, increased by a predetermined increment or, in each case, lessened by a predetermined decrement.

In a third embodiment of the invention, it is provided that the memory content comprises a numerical value for a time variable representing a point in time, for example, an operating time and/or a date and clock time, of activating the second operating mode.

In a fourth embodiment of the invention, it is provided that the memory content comprises a numerical value for a time variable representing a point in time, for example, an operating time and/or a date and clock time, of an activating of the first operating mode.

In a fifth embodiment of the invention, the memory unit is adapted to store at least one time value corresponding to an activating of the second operating mode, for example, in the form of a combination of a corresponding date and/or a corresponding clock time, and/or to store at least one data value present on the data output at a point in time of an activating of the second operating mode, for example, in combination with an operating time passed since a prior start-up and/or in combination with a corresponding date and/or a corresponding clock time. Furthermore, the memory unit can additionally also be adapted supplementally to store also at least one time value corresponding to a deactivating of the second operating mode, for example, in the form of an operating time passed since a prior start-up and/or in the form of a combination of a corresponding date and/or a corresponding clock time.

In a sixth embodiment of the invention, the memory unit is, furthermore, adapted to store at least one time value corresponding to an activating of the first operating mode, for example, in the form of an operating time passed since a prior start-up and/or in the form of a combination of a corresponding date and/or a corresponding clock time.

In a first further development of the invention, the electronic device further comprises an adapter, which is adapted to receive from an external servicing device, for example, per radio, by means of infrared light or via a two wire cable, a control command requesting an activating of the second operating mode and to convert such on the control input of the microprocessor into a signal level pattern, for example, in the form of a bit sequence, activating the second operating mode. The adapter can, for example, be adapted to receive said control command from the servicing device wirelessly, for example, per radio or by means of infrared light, and/or by wire, for example, via a two wire cable. The adapter can, in such case, especially, be adapted to receive from the servicing device wirelessly per radio a control command transmitted according to an industrial standard IEEE 802.15.1 (Bluetooth) for short distance radio connections and/or according to an industrial standard IEEE 802.15.4 (wireless HART) and thereafter to process, namely to convert, such into the signal level pattern activating the second operating mode. Furthermore, the adapter can also be adapted to receive a control command from the servicing device transmitted by wire via a two wire cable according to a standard IEC 61158 (HART) and thereafter to process such, namely to convert such, into the signal level pattern activating the second operating mode.

In a second further development of the invention, the electronic device further comprises an electronics housing, within which are accommodated the microprocessor as well as the persistent memory.

In a third further development of the invention, the electronic device further comprises a manually actuatable, for example, sealable and/or compartmentalizable, switch, which is adapted, upon actuation, to generate on the control input of the microprocessor a signal level pattern, for example, in the form of a bit sequence, activating the second operating mode, for example, both activating the second operating mode as well as also at the same time deactivating the first operating mode. Especially, the electronic device can in the case of this further development, furthermore, also comprise a seal applied to the switch, for instance, a seal formed by means of a wax or lead seal or by means of an adhesive label. Moreover, the switch can, furthermore, be adapted, after a corresponding actuation, to generate on the control input of the microprocessor a signal level pattern, for example, in the form of a bit sequence, deactivating the second operating mode, for example, both deactivating the second operating mode as well as also at the same time activating the first operating mode.

In a fourth further development of the invention, the electronic device additionally comprises a display element, which is adapted to visualize the frequency, as represented by the memory content of the memory unit, with which the second operating mode has been activated within the predetermined period of time, and/or to signal, which operating mode is activated at the moment.

In a fifth further development of the invention, the electronic device further comprises a measuring transducer—for example, a magneto-inductive flow transducer, an ultrasonic, flow transducer, a thermal mass flow sensor, a vortex flow sensor, a Coriolis mass flow transducer, a vibronic density transducer, a vibronic viscosity transducer, a pressure sensor, a pH-sensor, a temperature sensor, etc.—for registering a physical and/or chemical, measured variable—for example, a density, a viscosity, a temperature and/or a pressure of a fluid, a volume flow rate, respectively a mass flow rate of a fluid conveyed in a line, a fill level or a limit level of a medium held in a container, etc.—and for generating measurement data, namely digital data, representing the at least one measured variable. Furthermore, the microprocessor is in the case of the further development of the invention adapted to receive the measurement data on the data input, and to process measurement data incoming via the data input in the first operating mode in execution of the process flow program, for example, also, in order in the first and/or in the second operating mode to output on the data output measured values, namely digital data calculated in execution of the process flow program and with application of the measurement data. Alternatively or supplementally, the memory unit can, furthermore, also be adapted to store at least one measured value ascertained by the microprocessor, for example, directly and/or last of all, before a point in time of an activating of the second operating mode, for example, in combination with an operating time passed since a preceding startup and/or in combination with a corresponding date and/or a corresponding clock time.

A basic idea of the invention is in the case of electronic devices of the type being discussed, not least of all also in the case of certification obligatory field devices, to improve required protective measures against tampering, namely against unauthorized modifications, consequently device integrity destroying modifications, of at least one process flow program after an acceptance of the respective electronic device such that possible intermediate accesses of the control program are automatically registered and then stored in the device in machine readable entries such that they are directly recallable and displayable on-site, and, indeed, in such a manner that any recent activating of the (special-) operating mode enabling modifications of the process flow program compels, in each case, automatically a corresponding change of a memory content in the memory unit, and, indeed, even before some modification of the control program can occur, respectively actually has occurred. The entries documenting activating can, in such case, be kept directly comparatively tamper safely in the respective device, when the accessing of the memory unit, respectively the memory content documenting the activating, occurs without exception via the microprocessor.

An advantage of the present invention, is, among other things, that, on the one hand, in very simple, equally as well very noticeable, manner, on-site, namely directly at the respective electronic device, it can be signaled, whether a tampering, consequently a destruction of the integrity, of the device must be cared for. On the other hand, for the case, in which upon each activating the memory content is changed according to a fixedly predetermined rule always in equal manner, for example, by a step-wise increasing of a memory content, embodied as a kind of counter level, by a predetermined increment and/or by corresponding supplementing of such an activating with a therewith corresponding date and/or a therewith corresponding clock time, it can additionally also be ascertained, how often, respectively, in given cases, also when, there was an entry into the second operating mode.

The invention as well as other advantageous embodiments thereof will now be explained in greater detail based on examples of embodiments shown in the figures of the drawing. Equal parts are provided in all figures with equal reference characters; when perspicuity requires or it otherwise appears sensible, already mentioned reference characters are omitted in subsequent figures. Other advantageous embodiments or further developments, especially also combinations, first of all, of only individually explained aspects of the invention, result, furthermore, from the figures of the drawing, as well as also from the dependent claims per se. In particular, the figures of the drawing show as follows:

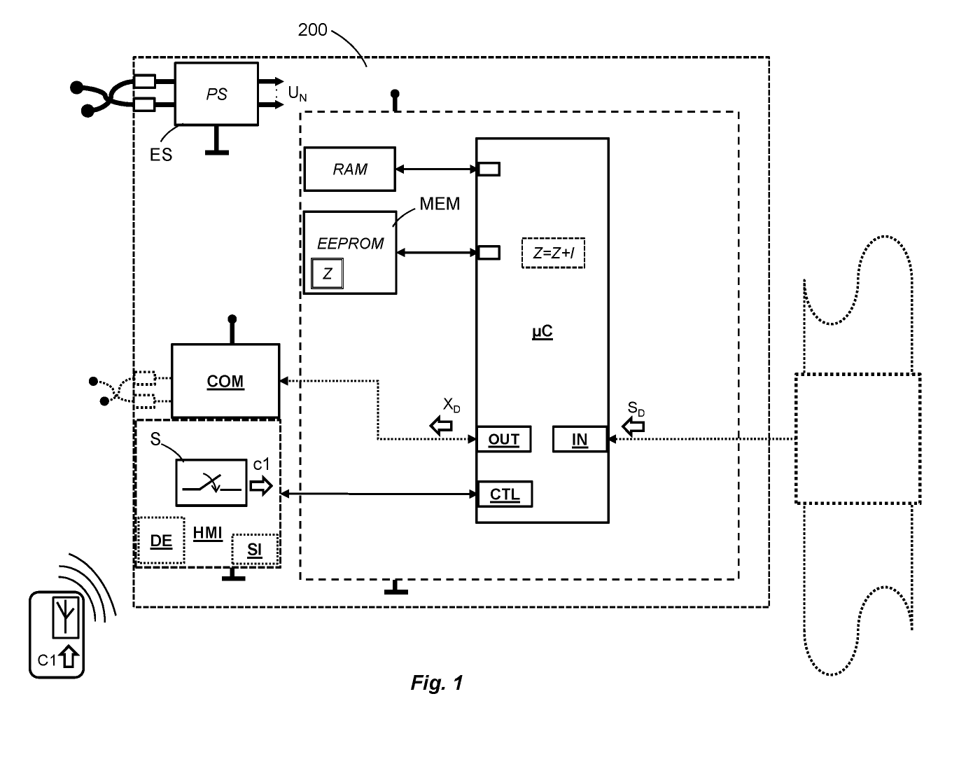

FIG. 1 schematically in the manner of a block diagram an electronic device, especially an electronic device suitable for application in industrial measuring and automation technology;

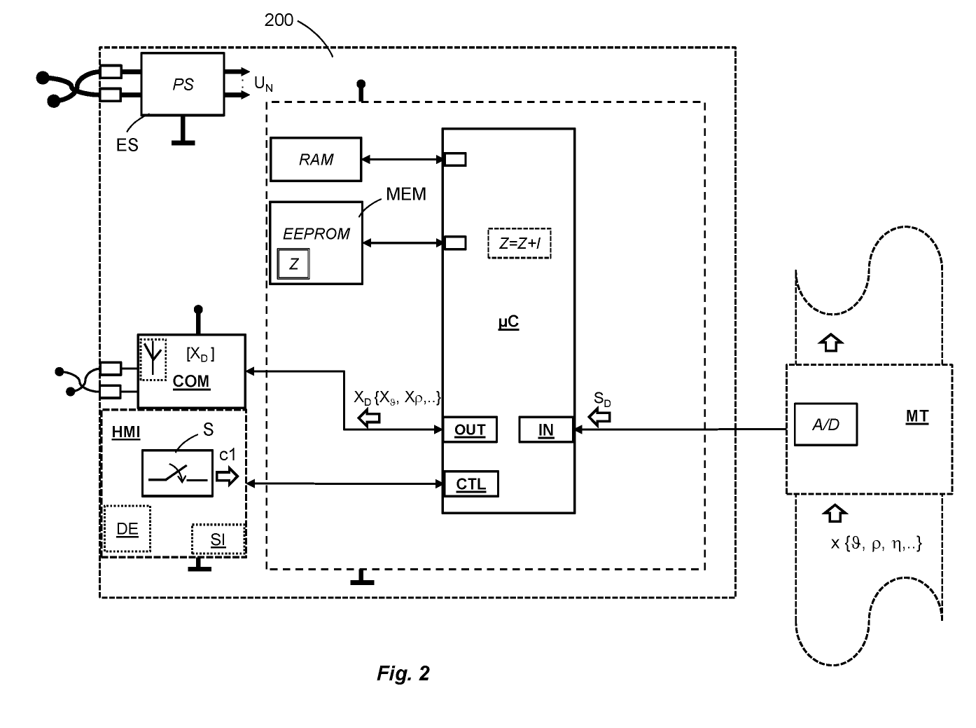

FIG. 2 schematically in the manner of a block diagram, the electronic device of FIG. 1, embodied as a measuring device;

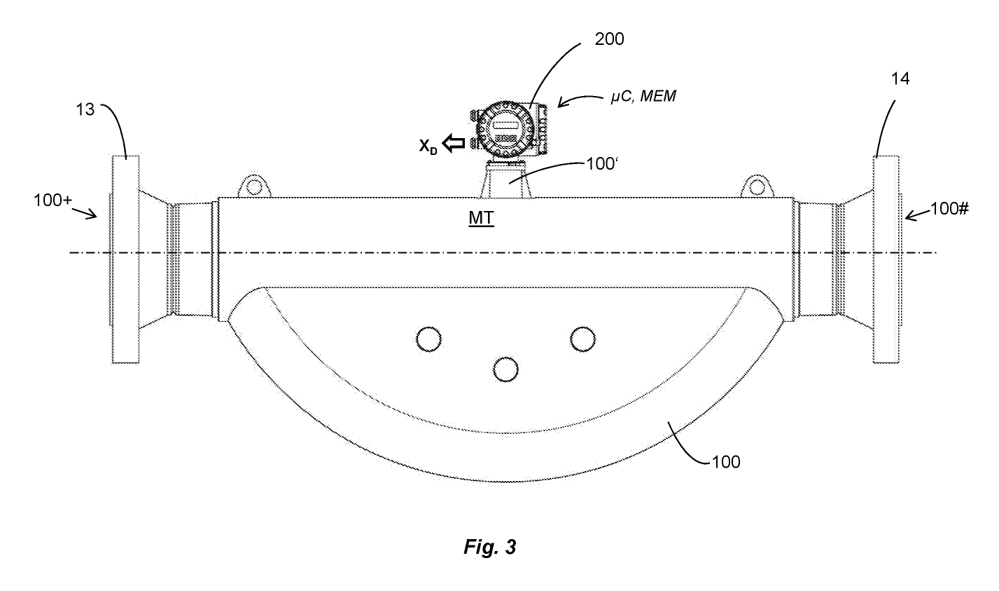

FIG. 3 the electronic device of FIG. 2 in a side view; and

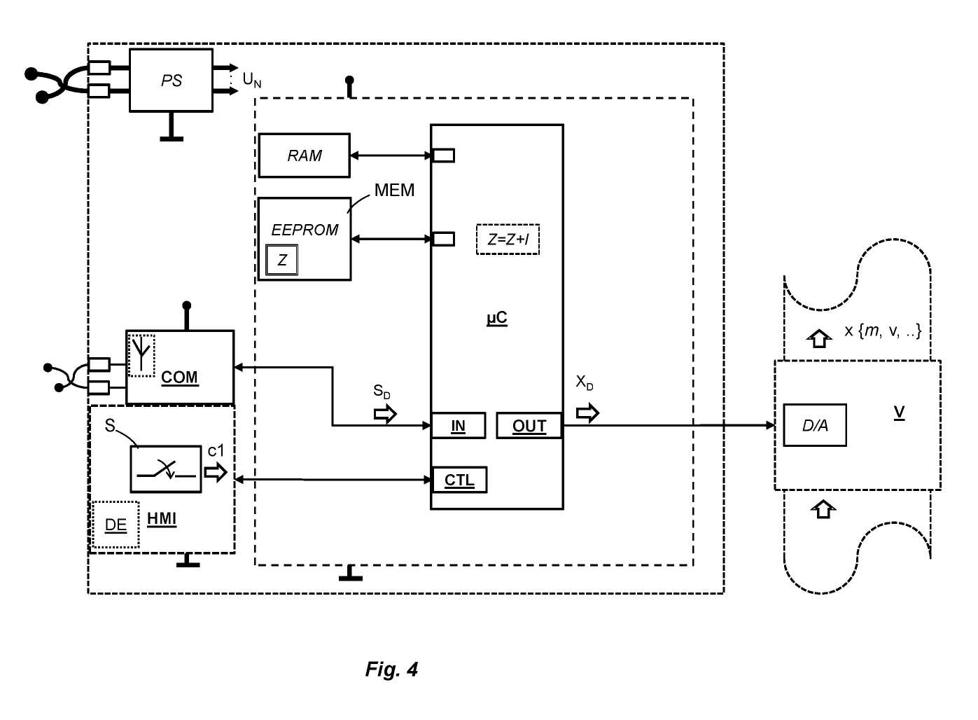

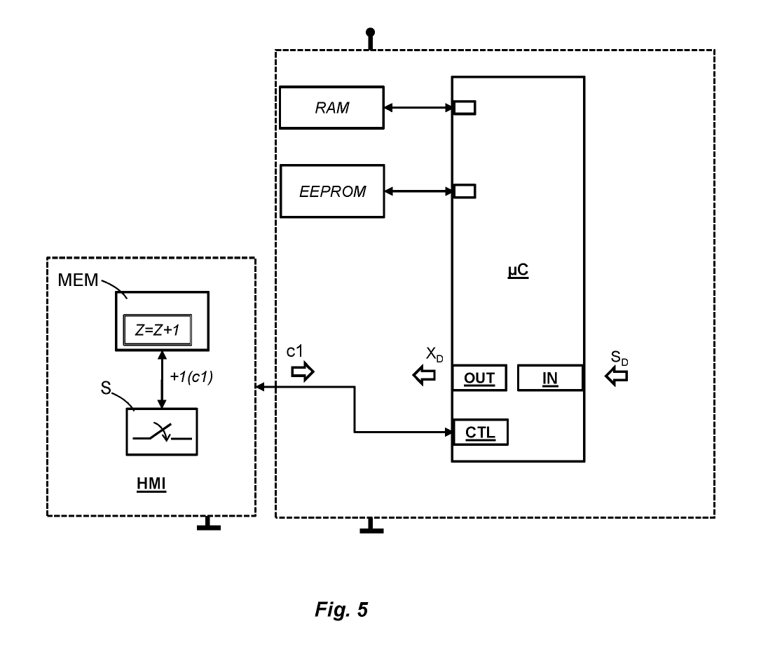

FIG. 4 schematically in the manner of a block diagram, the electronic device of FIG. 1, embodied as an actuator field device.

FIG. 1 shows schematically in the manner of a block diagram an example of an embodiment of an electronic device, especially an electronic device suitable for application in industrial measuring and automation technology. The electronic device can be embodied, respectively used, for example, as well as also schematically shown in FIG. 2, as a sensor field device, namely, for example, as a measuring device for registering a physical variable of a medium flowing in a pipeline or a medium held in a supply container, or, however, also, such as shown schematically in FIG. 4, as an actuator field device, for example, an electronic control unit for a motor- or a valve V. The electronic device comprises a microprocessor ρC having a data input IN, a data output OUT as well as a control input CTL. The microprocessor ρC is, according to an additional advantageous embodiment of the invention, accommodated in a corresponding electronics housing 200, especially an impact- and/or also explosion-resistantly and/or hermetically sealedly formed and/or modularly assembled, electronics housing 200. Furthermore, the electronic device in the example of an embodiment shown here includes, furthermore, an energy supply circuit ES fed by an external energy supply. The energy supply circuit ES has an input having two connection contacts, and at least one output, which is likewise accommodated within the electronics housing. The energy supply circuit ES serves to provide on the output a electrical, effective power required for operation of the device with at least one useful voltage U_{N} matched especially also to the voltage required by the microprocessor μC.

The microprocessor μC of the electronic device of the invention includes, furthermore, at least two operating modes selectively activatable, for example, by means of correspondingly set, binary signal levels, respectively clock sequences formed therewith, placed on the control input CTL. Especially, the microprocessor is namely adapted, in a first operating mode, to execute at least one predetermined control program, in order, such as schematically shown in FIG. 1, to process digital data SD incoming via the data input IN, for example, digital measured values supplied to the microprocessor, and/or in order to output digital data X_{D}, for example, also in real time, on the data output OUT. For executing the mentioned process flow program, the electronic device includes, furthermore, electrically connected with the microprocessor —, for example, accommodated with the microprocessor together on one and the same microchip—a volatile memory chip (RAM) configured as working memory, which enables a direct access of the microprocessor μC and into which the corresponding compiled control program can be loaded for the purpose of its execution by the microprocessor during run time. Furthermore, the device can have, for example, implemented by means of the microprocessor or by means of a separate chip (IC), a real time clock for ascertaining a current clock time and/or, for example, implemented by means of the microprocessor, an operating hours counter for ascertaining time passed since a preceding start-up—or also since another point in time relevant for the operation of the device.

In order to enable a dialog between the electronic device and a user interacting on-site therewith, the electronic device is provided, furthermore, with a corresponding human machine interface HMI. This can have e.g. a display, respectively display and interaction, element DE communicating with the microprocessor μC, especially one operated by the microprocessor and/or a portable one, such as, for instance, an LCD-, OLED- or TFT display placed in the electronics housing 200 behind a corresponding window provided therein as well as a corresponding input keypad and/or a touch screen, which, for example, is also adapted to display on-site, namely directly on the device, the digital data X_{D} generated by the microprocessor. Additionally, the human machine interface HMI can also provide together with an external servicing device a communication connection, for example, a radio wave based, an infrared light based or a wired data connection, via which a user can transmit on-site via the servicing device commands to the electronic device for controlling the microprocessor.

For forming such a communication connection embodied, for example, according to one of the industry standards IEEE 802.15.1 (Bluetooth) for short distance radio connections, IEEE 802.15.4 (wireless HART), respectively IEC 61158 (HART), the electronic device according to an additional embodiment includes an adapter SI, which is adapted to receive from an external servicing device, for example, per radio, by means of infrared light or via a two wire cable, one or more control commands influencing the microprocessor, respectively the execution of the respectively loaded process flow program and to convert such into corresponding signal patterns on one or more control inputs of the microprocessor, especially also the mentioned control input CTL.

Moreover, in the example of an embodiment shown here, the data, for instance, measuring and/or other operating data, generated by means of the microprocessor can be sent, in given cases, also in real time, during operation by means of a data communication interface COM provided in the electronic device to an electronic data processing system superordinated to the electronic device, for example, a programmable logic controller (PLC), a personal computer and/or a work station, via a data transmission system coupled to the data communication interface COM, for example, an Ethernet, a fieldbus and/or a radio network, in order there to be further evaluated, respectively further processed.

In addition to the first operating mode, the microprocessor of the electronic device of the invention includes a second operating mode, in which the microprocessor is reprogrammable in such a manner that the at least one control program is modifiable, namely at least one value of a parameter, which influences the execution of the mentioned process flow program by the microprocessor, is changeable. Said second operating mode can be activatable, for example, alternatively to the first operating mode, in such a manner that simultaneously at most one of the two operating modes is active, respectively that the two operating modes are mutually exclusive. Alternatively thereto, the microprocessor can, however, also so be adapted that the second operating mode, in case required, is activatable simultaneously with the first operating mode, for example, in such a manner that the microprocessor can execute the at least one control program and parallel thereto modifications can be performed on at least one control program, for example, also a program other than the one executed by the microprocessor at the moment. In an additional embodiment of the invention, the microprocessor is additionally adapted such that each of the two operating modes is selectively activatable exclusively—via the control input CTL. In case required, the microprocessor can additionally also be so adapted that the activating at least of the second operating mode can occur only after successful input of a corresponding password via the human machine interface HMI, for example, by means of the display and interaction element DE, in given cases, contained therein.

In order at least from a certain point in time—for example, corresponding to a last accomplished calibrating, respectively certification, of the electronic device—to enable a documentation, respectively a tracing, of modifications possibly performed on process flow programs to be performed by the microprocessor, the electronic device of the invention includes, such as schematically shown in FIG. 1, furthermore, at least one memory unit MEM—here accommodated together with the microprocessor in the same electronics housing 200. Memory unit MEM is adapted, upon each activating of the second operating mode, to react with a change of a memory content Z, and, indeed, in such a manner that the memory content Z represents a frequency, with which the second operating mode has been activated within a predetermined period of time. The predetermined time range can be, for example, a monitoring interval extending from the previously indicated (earlier) point in time, namely that corresponding to the last accomplished calibrating, respectively certification, of the electronic device, up to a later point in time, for example, a point in time corresponding to a new checking of the device.

Said frequency represented by the memory content Z of the memory unit MEM, namely the frequency, with which the second operating mode has been activated within the predetermined period of time, can, for example, also be visualized by means of the mentioned display element DE, in order then to be able to be compared, for example, with an older memory content kept written in an older test protocol, respectively to be correspondingly noted in the current test protocol. Alternatively thereto or in supplementation thereof, the display element DE can, for example, also display, consequently signal, which operating mode is activated at the moment, respectively whether the second operating mode was ever reactivated after the activating the first operating mode.

The memory unit MEM can be formed, such as schematically shown in FIG. 1, for example, by means of a persistent, namely non-volatile, electronic memory component electrically connected with the microprocessor μC—, for example, also an electronic memory component integrated together with the microprocessor μC in a single chip. Equally as well, the memory content of the electronic memory component can be changeable via the microprocessor. For example, the memory unit MEM can be an electrically erasable, programmable, read only memory, consequently one formed by means of an EEPROM or a flash EEPROM, respectively by means of a memory range correspondingly reserved on such a memory chip.

For the case, in which it is sufficient for documentation, respectively tracing, only to note how often within the predetermined period of time the second operating mode was entered, it can, for example, suffice, when by means of the memory unit MEM in interaction with the microprocessor μC a software counter, namely such a function, is provided, in the case of which the memory content Z represents a counter level and in the case of which the instantaneous memory content Z representing the current counter level before the activating the second operating mode is changed according to a simple calculation function Z=Z+I implemented by means of the microprocessor μC, namely calculated anew in the case of each activating of the second operating mode, so that the counter level is incremented by a predetermined, namely, in each case, one and the same, magnitude I. As a result, the current memory content Z corresponds to an initial memory content Z′ — for example, the memory content for the point in time of a most recent approval, respectively certification, of the device —, increased by the number N of activations of the second operating mode undertaken in the meantime multiplied by the magnitude I (Z=Z′+N I), consequently the number N of the activations of the second operating mode executed in the meantime can be ascertained in very simple manner according to the formula N=(Z−Z′)/I. Therefore, the memory content Z according to an additional embodiment of the invention comprises a numerical value for a counter variable representing a counter level, which numerical value in the case of each activating of the second operating mode is increased, in each case, by a predetermined increment, for example, by one, or, in each case, lessened by a predetermined decrement, for example, by one. For the case, in which the memory content Z corresponds only to such a counter level, the memory unit MEM—alternatively or in supplementation to the previously indicated electrically erasable programmable read only memory—can also be embodied as an electronic counter, for example, in the form of a flip flop circuit configured as a pulse counter, which is triggered by means of a switch command, for example, a switch command output by the microprocessor and representing an activating of the second operating mode, in such a manner that the electronic counter reacts to each new activating of the second operating mode with an incremental change of a switch state forming the memory content Z.

Alternatively or supplementally to the previously indicated variant, in the case of which by means of the memory unit MEM the activations of the second operating mode are counted, respectively in the case of which the memory content Z corresponds to a counter level numerically giving the frequency of said activations,—not least of all also for the case, in which the memory unit MEM is formed by means of the previously indicated electronic memory component (EEPROM)—with interaction of microprocessor μC and memory unit MEM additionally also a protocol file can be implemented, namely a function provided, in the case of which the memory content Z represents a point in time of an activating of the second operating mode, for example, the last performed activating, and in the case of which the memory content Z of the memory unit MEM is supplemented by a time value representing a current system time according to a time registration function implemented by means of the microprocessor, for example, also with application of the real time clock provided, in given cases, in the device, respectively with application of the operating hours counter provided, in given cases, in the device, and executed anew at each activating of the second operating mode. The memory content Z can even be replaced by the mentioned time value, in given cases, also in combination with a remark confirming in text form the activating of the second operating mode. Said point in time of an activating of the second operating mode can, in such case, be noted in the memory unit, for example, in the form of a date and clock time or in the form of an operating time passed since a prior start-up. Therefore, the memory content Z according to another embodiment comprises a numerical value for a time variable representing a point in time, for example, a date and clock time and/or an operating time passed since a preceding start-up, of an activating of the second operating mode, respectively the persistent memory is adapted to store at least one time value corresponding to an activating of the second operating mode, for example, thus the time value in the form of a combination of a corresponding date and/or a corresponding clock time and/or in the form of an operating time passed since a prior start-up. Alternatively thereto or in supplementation thereof, the memory content Z can, for example, also comprise a numerical value for a time variable representing a point in time of an activating of the first operating mode, especially a date and clock time and/or a counter level of the, in given cases provided, operating hours counter, respectively the persistent memory can be adapted to store at least one time value corresponding to an activating of the first operating mode, for instance, in the form of an operating time passed since a prior start-up and/or in the form of a combination of a corresponding date and/or a corresponding clock time. Particularly for the case, in which the second operating mode is activatable independently of whether the first operating mode is activated or deactivated, it can, moreover, also be advantageous to adapt the memory unit MEM to store at least one time value corresponding to a deactivating of the second operating mode, for instance, a time value in the form of a combination of a corresponding date and/or a corresponding clock time and/or in the form of an operating time passed since a prior start-up. Furthermore, the memory unit MEM can be adapted to store at least one data value present on the data output at a point in time of an activating of the second operating mode, for example, in combination with a corresponding time value.

For selective activating at least of the second operating mode, the electronic device includes according to an additional embodiment of the invention a manually actuatable switch S, for example, a switch S manually actuatable by an examiner charged with the calibrating or certification of the device. The switch is adapted, upon actuation, to generate on the control input CTL of the microprocessor μC a corresponding signal level pattern c1, namely a signal level pattern activating the second operating mode. Serving as signal level pattern c1 can be, for example, a bit sequence, namely a clock sequence formed by means of an alternating signal level, which binary codes a corresponding control word, namely a control word triggering the activating of the second operating mode; the signal level pattern c1 can, however, for example, also be a single change from a low level representing a logical zero to a high level representing a logical one or, conversely, a change from a high to a low level. For the mentioned case, in which the first and second operating modes are only alternatively activatable, control command c1 and microprocessor μC can in advantageous manner also be so matched to one another that by means of the control command c1 both the second operating mode is activated as well as also at the same time the first operating mode is deactivated. In an additional embodiment, the switch is, furthermore, adapted, upon a corresponding actuation, to generate on the control input CTL of the microprocessor a signal level pattern c2, for instance, in the form of a corresponding bit sequence, deactivating the second operating mode, for example, also both deactivating the second operating mode as well as also at the same time activating the first operating mode. For example, the switch can, matched to the microprocessor, in such case, also be embodied as an alternating switch, in such a manner that each actuation of the switch S places on the control input alternately either the signal level pattern activating the second operating mode c1 or the signal level pattern c2 activating the first operating mode. Although alone already by the interaction of microprocessor, memory unit and switch a reliable documentation concerning the activating, in given cases, also non-authorized activating, of the second operating mode is enabled, it can be advantageous, not least of all for reasons of providing a correspondingly noticeable signaling of the fact that a special permission is required to activate the momentarily deactivated second operating mode, respectively to be permitted to perform a modification of the control program, to secure the switch by means of a seal mounted thereon, for example, by means of a seal in the form of a wax or lead seal. Alternatively or supplementally to such a sealing of the switch, it can also be advantageous, for example, to integrate a corresponding closure mechanism in the switch, for example, in such a manner that the switch can be made operable or locked by means of a skeleton key valid for a predetermined plant region. Moreover, the switch S can, such as schematically shown in FIG. 2, be arranged in advantageous manner within the electronics housing 200, for example, in such a manner that it is reachable from the outside, consequently actuatable, only after the electronics housing 200 has been opened, for example, by removal of a lid of the housing.

Instead of the switch S or supplementally thereto, the activating, respectively deactivating, at least of the second operating mode can, in given cases, also occur by means of the aforementioned adapter SI, respectively via a communication connection adapted therewith, for example, also according to one of the mentioned industry standards IEEE 802.15.1, IEEE 802.15.4 and/or IEC 61158. For such purpose, the mentioned adapter SI is according to an additional embodiment of the invention adapted to receive from an external servicing device, for example, thus per radio, by means of infrared light or via a two wire cable, a control command requesting an activating of the second operating mode C1 and to convert the mentioned control command C1 into the signal level pattern on the control input CTL activating the second operating mode c1. The adapter can, furthermore, also be provided for receiving from the mentioned servicing device also a control command C2 requesting an activating of the first operating mode and for converting such into a signal level pattern c2 on the control input CTL activating the first operating mode.

In an additional embodiment of the invention, the electronic device is provided as a measuring device, for example, a measuring device to be used in applications of industrial measuring and automation technology or in certification obligatory traffic in goods, namely for ascertaining measured values for at least one physical and/or at least one chemical, measured variable x, for example, a density, a viscosity, a temperature and/or a pressure of a fluid, a volume flow rate, respectively a mass flow rate, of a fluid flowing in a line, especially a pipeline or a flume, or a fill level or a limit-level of a medium, especially a liquid or a bulk good, held in a container, especially in a tank or a vat. Especially, the electronic device is provided to ascertain, respectively to output, measured values for at least one such physical, respectively chemical, measured variable x of a medium conveyed in a transfer system, for example, a filling plant or a bottling plant. As regards sensors registering the at least one measured variable x, the electronic device comprises, such as shown schematically in FIG. 2, respectively 3, furthermore, a measuring transducer MT—for example, a measuring transducer MT protected by means of an impact and pressure resistant, transducer housing 100 against external environmental influences, respectively against possible emissions to the environment. The measuring transducer MT is adapted to register the at least one physical, respectively chemical, measured variable and to generate measurement data, namely digital data s_{D} representing the at least one measured variable. The measuring transducer can be, for example, a magneto-inductive flow transducer, an ultrasonic, flow transducer, a thermal mass flow sensor, a vortex flow sensor, a Coriolis mass flow transducer, a vibronic density transducer, a vibronic viscosity transducer, a pressure sensor, a pH-sensor, a temperature sensor, etc. In the case of this embodiment of the invention, the electronics housing 200 can, for example, such as directly evident from a combination of FIGS. 2 and 3, be mounted directly on the measuring transducer MT, in order to form a measuring device of compact construction. For example, the electronics housing 200 can be mounted on a neck piece 100′ provided outwardly on the transducer housing 100. Additionally, the microprocessor is, furthermore, adapted to receive the measurement data on the data input, as well as to process measurement data incoming via the data input in the first operating mode in execution of the process flow program; this is done, for example, in such a manner that the microprocessor in the first operating mode outputs on the data output measured values, namely digital data calculated in the execution of the process flow program and with application of the measurement data. The digital measurement data can, in turn, thereafter, for instance, in order to be able to output by means of the electronic device an analog unit signal conformal to the standard DIN IEC 60381-1 or DIN IEC 60381-2, be converted correspondingly into an analog voltage- or an analog electrical current signal, for example, a loop current variable within an electrical current range from 4-20 mA. In an additional embodiment of the invention, the microprocessor is, furthermore, also adapted to process measurement data occurring in the second operating mode on the data input, respectively to output corresponding measured values on the data output. Furthermore, it can, in such case, also be advantageous, for instance, in order subsequently to be able to separate a batch of the medium measured by means of certified device from a later batch of the medium measured, in given cases, with a no longer certified device, to adapt the memory unit MEM such that it stores at least one measured value ascertained before a point in time of an activating of the second operating mode by the microprocessor—for example, the measured value ascertained directly before the mentioned activating, respectively the last ascertained measured value —, in given cases, also in combination with an operating time passed since a preceding startup and/or in combination with a corresponding date and/or a corresponding clock time.

1-22. (canceled)

23. An electronic device, comprising:
a microprocessor having a data input, a data output and a control input; as well as at least one memory unit, especially a memory unit formed by means of a persistent memory component, wherein:
said microprocessor includes at least two operating modes, especially operating modes selectively activatable exclusively via said control input, especially by means of a binary signal level, respectively clock sequences formed therewith;
said microprocessor is adapted;
to execute in a first operating mode at least one predetermined control program, in order to process digital data incoming via said data input, especially to digital measured values, and/or in order to output digital data, especially in real time, on said data output; and
in a second operating mode, especially activatable alternatively to or simultaneously with said first operating mode, to be reprogrammable, in such a manner that at least one value of a parameter, which influences execution of the at least one process flow program by said microprocessor, is changeable;
and said memory unit is adapted, to react to each activating of said second operating mode with a change of a memory content, in such a manner that said memory content, represents a frequency, with which said second operating mode has been activated within a predetermined period of time.

24. The electronic device as claimed in claim 23, wherein:
said microprocessor is adapted not to be reprogrammable in said first operating mode, especially in such a manner that the value of no parameter influencing the execution of the at least one process flow program by said microprocessor is changeable.

25. The electronic device as claimed in claim 23, wherein:
said memory content comprises a numerical value for a counter variable representing a counter level, which numerical value in the case of activating said second operating mode, in each case, is changed by a predetermined magnitude, especially one, especially, namely, in each case, increased by a predetermined increment or, in each case, lessened by a predetermined decrement.

26. The electronic device as claimed in claim 23, wherein:
said memory content comprises a numerical value for a time variable representing a point in time, especially an operating time and/or a date and clock time, of activating the second operating mode; and/or
said memory content comprises a numerical value for a time variable representing a point in time, especially an operating time and/or a date and clock time, of activating said first operating mode.

27. The electronic device as claimed in claim 23, wherein:
said memory unit is adapted to store at least one time value corresponding to an activating of said second operating mode, especially in the form of a combination of a corresponding date and/or a corresponding clock time; and/or
said memory unit is adapted to store at least one data value present on the data output at a point in time of an activating of said second operating mode, especially in combination with an operating time passed since a preceding startup and/or in combination with a corresponding date and/or a corresponding clock time.

28. The electronic device as claimed in claim 23, wherein:
said memory unit is adapted to store at least one time value corresponding to a deactivating of said second operating mode, especially in the form of an operating time passed since a prior start-up and/or in the form of a combination of a corresponding date and/or a corresponding clock time.

29. The electronic device as claimed in claim 23, wherein:
said memory unit is adapted to store at least one time value corresponding to an activating of said first operating mode, especially in the form of an operating time passed since a prior start-up and/or in the form of a combination of a corresponding date and/or a corresponding clock time.

30. The electronic device as claimed in claim 23, further comprising:
an adapter, which is adapted to receive from an external servicing device, especially per radio, by means of infrared light or via a two wire cable, a control command requesting an activating of said second operating mode and to convert such on said control input of said microprocessor into a signal level pattern, especially in the form of a bit sequence, activating said second operating mode.

31. The electronic device as claimed in claim 30, wherein:
said adapter is adapted to receive said control command from said servicing device wirelessly, especially per radio or by means of infrared light, and/or by wire, especially via a two wire cable.

32. The electronic device as claimed in claim 30, wherein:
said adapter is adapted to receive from said servicing device wirelessly per radio said control command, especially a control command transmitted according to an industrial standard IEEE 802.15.1 (Bluetooth) for short distance radio connections and/or according to an industrial standard IEEE 802.15.4 (wireless HART).

33. The electronic device as claimed in claim 30, wherein:
said adapter is adapted to receive from said servicing device by wire via a two wire cable said control command, especially a control command transmitted according to a standard IEC 61158 (HART).

34. The electronic device as claimed in claim 23, further comprising:
an electronics housing, within which are accommodated said microprocessor as well as the persistent memory.

35. The electronic device as claimed in claim 23, further comprising:
a manually actuatable, especially sealable and/or compartmentalizable, switch, which is adapted to generate on said control input of said microprocessor a signal level pattern, especially in the form of a bit sequence, activating said second operating mode, especially both activating said second operating mode as well as also at the same time deactivating said first operating mode.

36. The electronic device as claimed in claim 35, wherein:
said switch is adapted to generate on said control input of said microprocessor a signal level pattern, especially in the form of a bit sequence, deactivating said second operating mode, especially both deactivating said second operating mode as well as also at the same time activating said first operating mode.

37. The electronic device as claimed in claim 35, further comprising:
a seal applied to said switch, especially a seal formed by means of a wax or lead seal or by means of an adhesive label.

38. The electronic device as claimed in claim 35, further comprising:
a display element, which is adapted to visualize the frequency represented by said memory content of said memory unit, with which said second operating mode has been activated within the predetermined period of time, and/or to signal, which operating mode is activated at the moment.

39. The electronic device as claimed in claim 35, further comprising:
a measuring transducer—especially a magneto-inductive flow transducer, an ultrasonic, flow transducer, a thermal mass flow sensor, a vortex flow sensor, a Coriolis mass flow transducer, a vibronic density transducer, a vibronic viscosity transducer, a pressure sensor, a pH-sensor, a temperature sensor, etc.—for registering a physical and/or chemical, measured variable especially a density, a viscosity, a temperature and/or a pressure of a fluid, a volume flow rate, respectively a mass flow rate of a fluid conveyed in a line, a fill level or a limit level of a medium held in a container—and for generating measurement data, namely digital data representing the at least one measured variable, wherein:
said microprocessor is adapted, to receive the measurement data on said data input; and
said microprocessor is adapted to process measurement data incoming via said data input in said first operating mode in execution of the process flow program.

40. The electronic device as claimed in claim 39, wherein:
said microprocessor is adapted in said first operating mode to output on said data output measured values, namely digital data calculated in execution of the process flow program and with application of said measurement data.

41. The electronic device as claimed in claim 40, wherein:
said microprocessor is adapted to output on the data output measured values also in said second operating mode.

42. The electronic device as claimed in claim 39, wherein:
said memory unit is adapted to store at least one measured value ascertained by said microprocessor, especially directly and/or last of all, before a point in time of an activating of said second operating mode, especially in combination with an operating time passed since a preceding startup and/or in combination with a corresponding date and/or a corresponding clock time.

43. Use of an electronic device in certification obligatory traffic in goods, especially for ascertaining measured values for a physical or chemical, measured variable of a medium, especially a fluid medium, especially a gas or a liquid, the electronic device comprising: a microprocessor having a data input, a data output and a control input; as well as at least one memory unit, especially a memory unit formed by means of a persistent memory component, wherein: said microprocessor includes at least two operating modes, especially operating modes selectively activatable exclusively via said control input, especially by means of a binary signal level, respectively clock sequences formed therewith; said microprocessor is adapted; to execute in a first operating mode at least one predetermined control program, in order to process digital data incoming via said data input, especially to digital measured values, and/or in order to output digital data, especially in real time, on said data output; and in a second operating mode, especially activatable alternatively to or simultaneously with said first operating mode, to be reprogrammable, in such a manner that at least one value of a parameter, which influences execution of the at least one process flow program by said microprocessor, is changeable; and said memory unit is adapted, to react to each activating of said second operating mode with a change of a memory content, in such a manner that said memory content, represents a frequency, with which said second operating mode has been activated within a predetermined period of time.

44. A method for operating an electronic device, comprising: a microprocessor having a data input, a data output and a control input; as well as at least one memory unit, especially a memory unit formed by means of a persistent memory component, wherein: said microprocessor includes at least two operating modes, especially operating modes selectively activatable exclusively via said control input, especially by means of a binary signal level, respectively clock sequences formed therewith; said microprocessor is adapted; to execute in a first operating mode at least one predetermined control program, in order to process digital data incoming via said data input, especially to digital measured values, and/or in order to output digital data, especially in real time, on said data output; and in a second operating mode, especially activatable alternatively to or simultaneously with said first operating mode, to be reprogrammable, in such a manner that at least one value of a parameter, which influences execution of the at least one process flow program by said microprocessor, is changeable; and said memory unit is adapted, to react to each activating of said second operating mode with a change of a memory content, in such a manner that said memory content, represents a frequency, with which said second operating mode has been activated within a predetermined period of time;
the method comprising the steps of:
activating the first operating mode for executing the at least one process flow program by means of the microprocessor;
activating the second operating mode for reprogramming the microprocessor;
and
modifying the memory content, by a predetermined magnitude in such a manner that the memory content, represents a frequency, which is increased by the amount of the magnitude and with which the second operating mode has been activated within a predetermined period of time.
